(19) United States
(12) Patent Application Publication
(10) Pub. No.: US 2014/0140902 A1
(43) Pub. Date: May 22, 2014

(54) COLLECTING TUBE AND APPARATUS FOR COLLECTING AN ORGANISM FROM A CULTURE MEDIUM

(71) Applicant: Kuan-Nan Chen, Taichung City (TW)

(72) Inventor: Kuan-Nan Chen, Taichung City (TW)

(21) Appl. No.: 13/681,281

(22) Filed: Nov. 19, 2012

(51) Int. Cl. B01L 3/00

(52) U.S. Cl. CPC B01L 3/508
USPC 422/549

(57) ABSTRACT

An apparatus for collecting an organism from a culture medium includes a collecting tube having a cutting end portion, and a suction unit connected to the collecting tube. The collecting tube is capable of penetrating into and incising the organism in the culture medium. The suction unit is capable of generating a suction force to draw the incised organism from the culture medium through the cutting end portion.

### BACKGROUND OF THE INVENTION

1. Field of the Invention

This invention relates to a collecting tube and an apparatus for collecting an organism, more particularly to a collecting tube and an apparatus for collecting an organism from a culture medium.

2. Description of the Related Art

Ever since in vitro cell culture has been developed, many types of organisms, e.g., cells and tissues, can now be grown in an in vitro culture system. In early days, cell culture is used for tumor virus research. Recently, demands for cells or tissues have further increased due to developments in medicine, immunity study, and biological and chemical products. Accordingly, automation and precision are required for further mass production of organisms.

In the early days, an organism in an in vitro culture system is collected manually using a knife and a microscope. A desired portion of the organism is incised and moved to another culture system using a small spoon. However, manual cell collection is inefficient as well as having a tendency to damage the organism due to inexperience.

Referring to FIG. 1, Taiwanese Patent No. I327165 discloses an organism collection apparatus including a tubular body 1 and a scraper 2. The scraper 2 comprises a connecting portion 21 connected to the tubular body 1, a scraping end 22, and an elastic portion 23 joining the connecting portion 21 and the scraping end 22. The elastic portion 23 deforms to enable the scraping end 22 to abut against a bottom of a culture container 31 so as to scrape an organism 32 in the culture container 31.

Before scraping, the organism 32 in the culture container 31 must be incised manually into a plurality of organism pieces 321. The tubular body 1 is lowered to make the scraping end 22 of the scraper 2 abut against the bottom of the culture container 31 followed by insertion of the scraping end 22 into an interface of the organism pieces 321 and the bottom of the culture container 31 so as to scrape the organism piece 321. The scraped organism piece 321 is sucked into the tubular body 1 using a suction device.

In the aforementioned Taiwanese Patent, since manual operation for dividing the organism 32 into the organism pieces 321 is required, the method for collecting the organism using the apparatus is inefficient. Organism damage is also observed since there is a distance between the tubular body 1 and the organism piece 321 to be sucked due to the design of the scraper 2 and the size of the organism piece 321 being not in accordance with the cross sectional area of the tubular body 1.

### SUMMARY OF THE INVENTION

Therefore, the object of this invention is to provide an apparatus and a collecting tube that can overcome the aforesaid organism damage and inefficient collection drawbacks of the prior art.

According to one aspect of this invention, an apparatus for collecting an organism from a culture medium includes a collecting tube having a cutting end portion capable of penetrating into and incising the organism in the culture medium, and a suction unit connected to the collecting tube and capable of generating a suction force to draw the incised organism from the culture medium through the cutting end portion.

According to another aspect of this invention, there is provided a collecting tube for penetrating into and incising an organism from a culture medium. The collecting tube includes a cutting end portion having an end edge defining an opening, and a knife extending into the opening from the end edge.

In this invention, since the organism is automatically incised using the cutting end portion and thus has the same size as the cross sectional area of the cutting end portion, collecting speed could be improved and damage to the organism could be alleviated.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of an organism collection apparatus disclosed in Taiwanese Patent No. I327165;

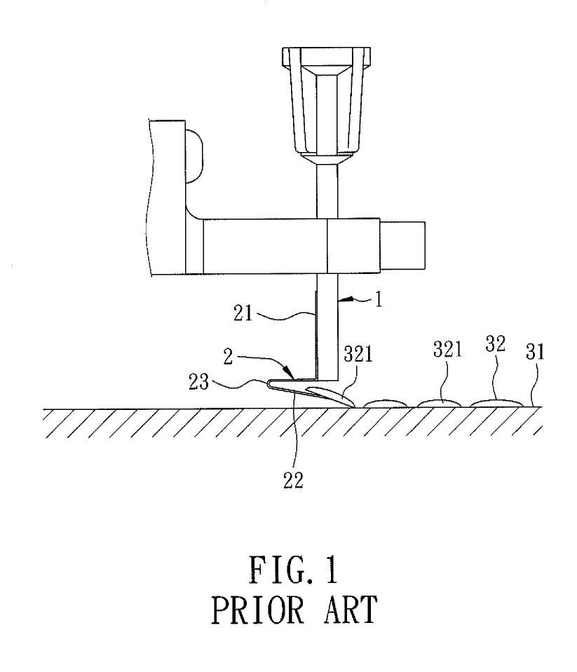

FIG. 2 is a schematic view illustrating the preferred embodiment of an organism collection apparatus of this invention;

FIG. 3 is a schematic view of the preferred embodiment shown in FIG. 2;

FIG. 4 is a fragmentary perspective view of a cutting end portion of a collecting tube of the preferred embodiment shown in FIG. 2;

FIG. 5 is a flowchart of the preferred embodiment of a method for collecting an organism from a culture medium using the apparatus shown in FIG. 2;

FIG. 6 is a schematic view showing the steps of penetrating the cutting end portion of the collecting tube into the organism in the culture medium and incising the organism according to the preferred embodiment of the method of this invention;

FIG. 7 is a schematic view showing the step of providing a suction force to draw the incised organism from the culture medium through the cutting end portion according to the preferred embodiment of the method of this invention; and

FIG. 8 is a schematic view showing the step of releasing the incised organism into another culture medium from the cutting end portion according to the preferred embodiment of the method of this invention.

### DETAILED DESCRIPTION OF THE PREFERRED EMBODIMENTS

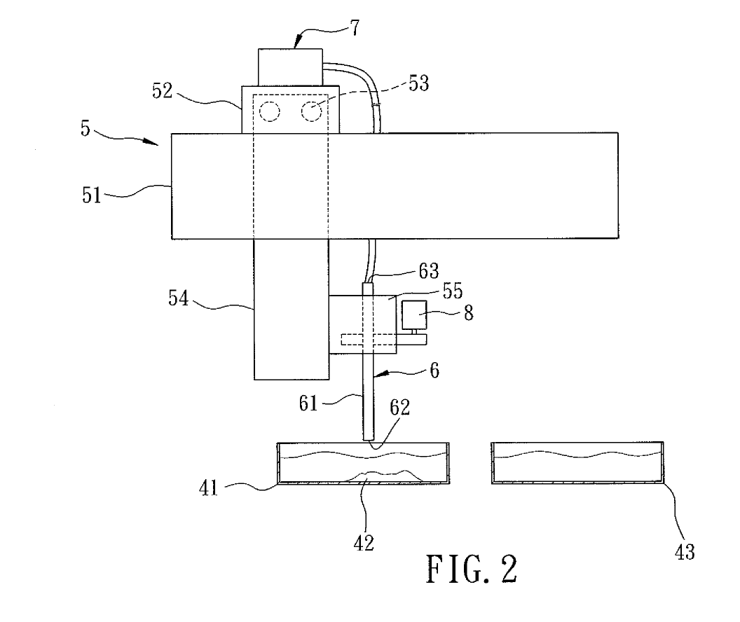

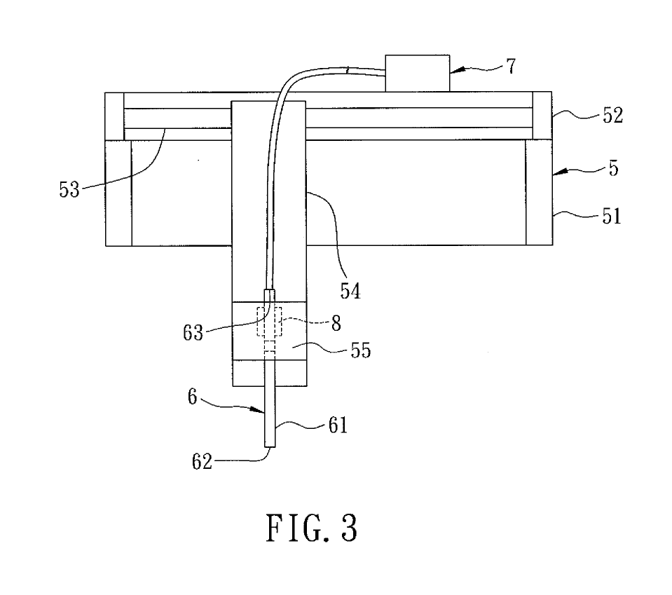

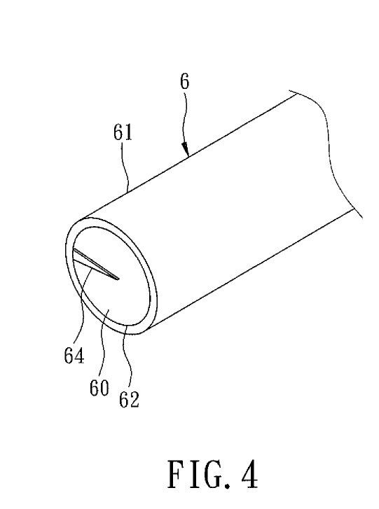

Referring to FIGS. 2, 3, and 4, the preferred embodiment of an organism collection apparatus of the present invention is used to collect an organism 42 in a first culture medium 41 and to move the organism 42 to a second culture medium 43. The organism collection apparatus includes a driving unit 5, a collecting tube 6, a suction unit 7, and a rotary actuator 8.

The driving unit 5 includes two seat members 51, and first, second, and third sliding members 52, 54, 55. The two seat members 51 are disposed along a first direction. The first sliding member 52 interconnects the two seat members 51 and extends in a second direction transverse to the first direction. The first sliding member 52 is slidable in the first direction relative to the seat members 51 and is formed with a first rail portion 53. The second sliding member 54 is connected to the first sliding member 52 and extends in a third direction transverse to the first and second directions. The second sliding member 54 is slidable in the second direction relative to the first sliding member 52 along the first rail portion 53. The second sliding member 54 is formed with a second rail portion (not shown). The third sliding member 55 mounted with the collecting tube 6 is connected to the second sliding member 54 and is slidable in the third direction relative to the second sliding member 54 along the second rail portion.

The collecting tube 6 extends rotatably from the third sliding member 55 in the third direction and includes a tube wall 61 that defines a retaining space 60 in the collecting tube 6. The collecting tube 6 has a cutting end portion 62 capable of penetrating into and incising the organism 42 in the first culture medium 41, and a connecting end portion 63 that is opposite to the cutting end portion 62 and that is connected to the suction unit 7. The cutting end portion 62 has an end edge defining a round shape opening. The collecting tube 6 is formed with a knife 64 that has a length larger than a radius of the round shape opening and that extends inwardly from the end edge of the cutting end portion 62 to scrape the organism 42 from the first culture medium 41.

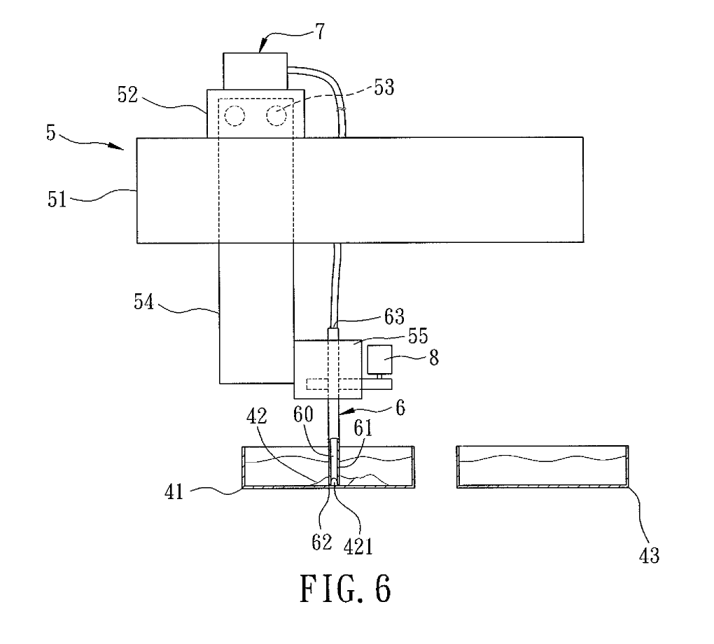

The suction unit 7 is connected to the connecting end portion 63 of the collecting tube 6 and is capable of generating a suction force to draw the incised organism 421 (see FIG. 6) from the first culture medium 41 through the cutting end portion 62 and retain the incised organism 421 in the collecting tube 6. For example, the suction unit 7 is a dosing pump or a pump with a check valve and a safety valve against over suction.

The rotary actuator 8 is coupled to the collecting tube 6 to rotate the collecting tube 6 about a rotary axis of the collecting tube 6. Examples of the rotary actuator 8 include a gear mechanism, a belt pulley mechanism, and the like. In this embodiment, the rotary actuator 8 is mounted on the third sliding member 55 of the driving unit 5.

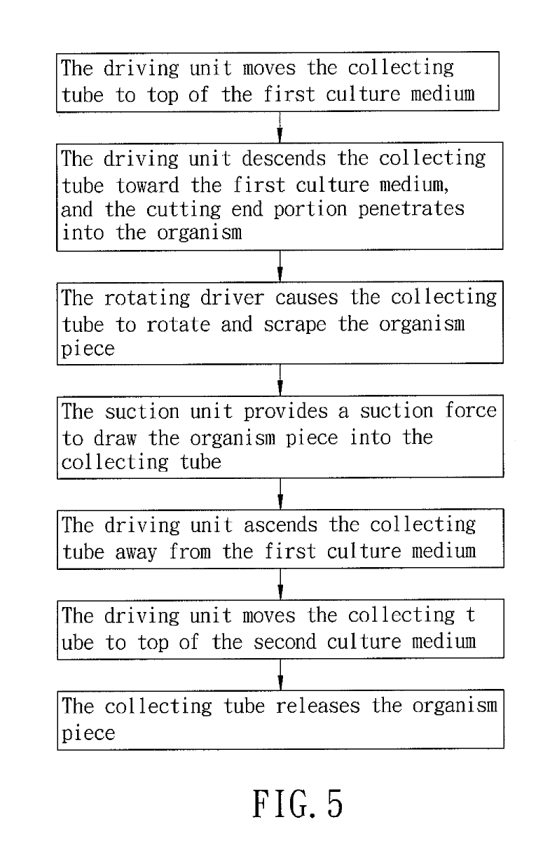

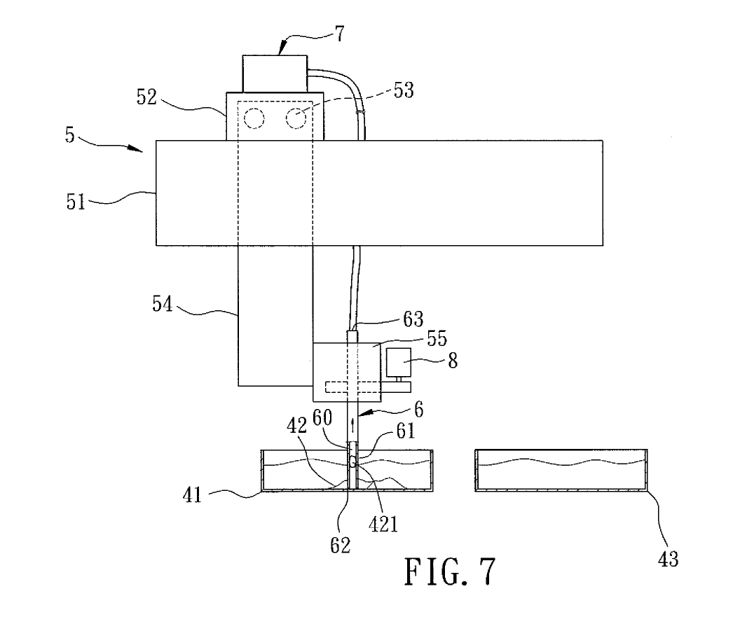

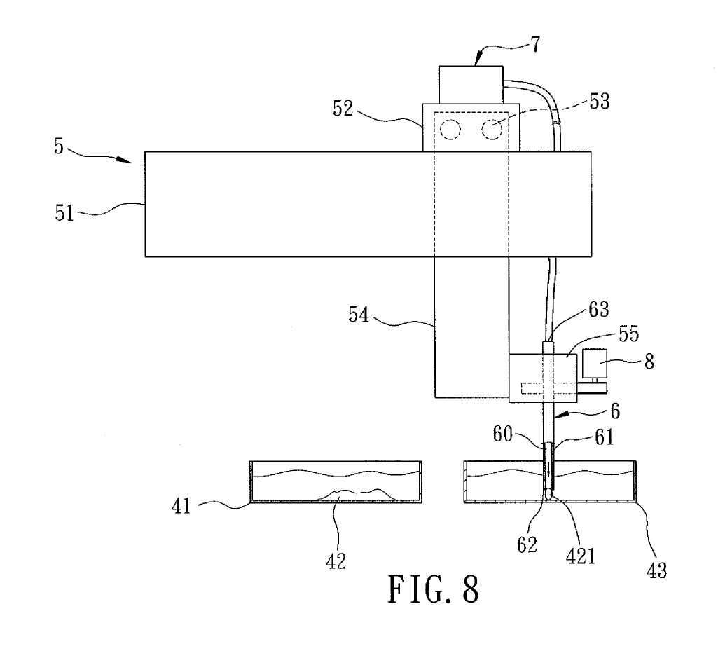

FIGS. 5, 6, 7, and 8 illustrate a method of using the aforesaid apparatus to collect the organism 42 from the first culture medium 41.

The first sliding member 52 moves relative to the seat members 51 along the first direction, and the second sliding member 54 moves relative to the first rail portion 53 along the second direction so as to carry the third sliding member 55 along with the collecting tube 6 to be disposed above the first culture medium 41.

The third sliding member 55 moves relative to the second rail portion along the third direction so as to be lowered toward the first culture medium 41. The cutting end portion 62 penetrates into the organism 42 and abuts against a bottom of the first culture medium 41 and incises a part of the organism 42 to obtain an organism piece 421.

The rotary actuator 8 drives the collecting tube 6 to rotate and scrape the organism piece 421 of the organism 42 from the first culture medium 41 using the knife 64.

The suction unit 7 provides a suction force to the collecting tube 6 so as to draw the organism piece 421 located at the cutting end portion 62 into the retaining space 60. At this time, the organism piece 421 is retained in the retaining space 60 through vacuum effect.

The collecting tube 6 ascends along the third direction through the movement of the third sliding member 55 relative to the second rail portion, and moves away from the first culture medium 41.

The collecting tube 6 moves along the first and second directions through the movement of the first and second sliding members 52, 54 relative to the seat members 51 and the first rail portion 53 so as to be disposed above the second culture medium 43.

The suction unit 7 pumps air into the collecting tube 6 to push out the organism piece 421 from the collecting tube 6 into the second culture medium 43.

Note that the step of rotating the collecting tube 6 to scrape the organism piece 421 from the first culture medium 41 using the knife 64 is applied to an adhesive organism. The rotating step can be omitted when the organism 42 is non-adhesive.

According to the aforesaid method and apparatus of this invention, since the organism 42 is automatically incised while the cutting end portion 61 of the collecting tube 6 penetrates into the organism 42, the incised organism 421 has a size the same as the cross sectional area of the cutting end portion 61 of the collecting tube 6, and no pre-cutting step for the organism 42 is required, thereby resulting in an improved collection efficiency and alleviating organism damage.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An apparatus for collecting an organism from a culture medium, comprising:
a collecting tube having a cutting end portion capable of penetrating into and incising the organism in the culture medium; and
a suction unit connected to said collecting tube and capable of generating a suction force to draw the incised organism from the culture medium through said cutting end portion.

2. The apparatus of claim 1, wherein said cutting end portion has an end edge defining an opening, said collecting tube including a knife that extends inwardly from said end edge.

3. The apparatus of claim 2, wherein said opening has a round shape, said knife having a length larger than a radius of said opening.

4. The apparatus of claim 1, further comprising a driving unit including:
at least one seat member that extends in a first direction;
a first sliding member that is connected to said seat member, that extends in a second direction transverse to the first direction, and that is slidable in the first direction relative to said seat member;
a second sliding member that extends in a third direction transverse to the first and second directions, that is connected to said first sliding member, and that is slidable in the second direction relative to said first sliding member; and
a third sliding member that is connected to said second sliding member, that is mounted with said collecting tube, and that is slidable in the third direction relative to said second sliding member.

5. The apparatus of claim 1, further comprising a rotary actuator for rotating said collecting tube about a rotary axis of said collecting tube.

6. The apparatus of claim 5, wherein said rotary actuator is coupled to said third sliding member, and said collecting tube is mounted rotatably on and extends from said third sliding member in the third direction.

7. The apparatus of claim 4, wherein said driving unit includes two of said seat members, said first sliding member interconnecting said seat members.

8. The apparatus of claim 4, wherein said first sliding member includes a first rail portion, said second sliding member being connected slidably to said first rail portion.

9. The apparatus of claim 4, wherein said second sliding member includes a second rail portion, said third sliding member being connected slidably to said second rail portion.

10. A collecting tube for penetrating into and incising an organism from a culture medium, comprising:
a cutting end portion having an end edge defining an opening; and
a knife extending into said opening from said end edge.

11. The collecting tube of claim 10, wherein said opening has a round shape, said knife having a length larger than a radius of said opening.
